(19) United States
(12) Patent Application Publication
(10) Pub. No.: US 2021/0145546 A1
(43) Pub. Date: May 20, 2021

(54) METHOD OF SELF DETERMINING THE DEGREE OF FIT OF AN ORTHODONTIC ALIGNER BY A PATIENT WITH THE PATIENT'S TEETH

(71) Applicant: Marc Lemchen, New York, NY (US)

(72) Inventor: Marc Lemchen, New York, NY (US)

(21) Appl. No.: 17/144,505

(22) Filed: Jan. 8, 2021

Related U.S. Application Data
(63) Continuation-in-part of application No. 16/855,868, filed on Apr. 22, 2020.
(60) Provisional application No. 62/850,462, filed on May 20, 2019.

(51) Int. Cl. A61C 7/08; A61C 7/00; A61C 19/04

(52) U.S. Cl. CPC A61C 7/08; A61C 2201/002; A61C 19/04; A61C 7/002

(57) ABSTRACT

A method of monitoring the degree of fit of an aligner among a series of aligners. First, an aligner in the series of aligners is selected whose fit to a patient's teeth are to be tested. Next the method includes disposing a nontoxic plastic material comprising an ultra violet reactive agent into the selected aligner, setting the patient's teeth into the selected aligner containing the material, and then illuminating the patient's teeth and the selected aligner with ultra violet light to determine the amount of material disposed onto the interior aligner's surfaces by visual inspection. The material disposed therein is then assessed, a good fit being indicated by a low degree of reflected ultra violet light from the disposed material, and a poor fit being indicated by a high degree of reflected ultra violet light from the disposed material.

### RELATED APPLICATIONS

The present application is a continuation in part application of U.S. application Ser. No. 16/855,868, filed on Apr. 22, 2020, which in turn is a non-provisional of U.S. provisional application Ser. No. 62/850,462, filed on May 20, 2019, which is incorporated herein by reference and to which priority is claimed pursuant to 35 USC 119, 120.

### BACKGROUND

### Field of the Technology

The invention relates to the field of orthodontics and in particular to use of orthodontic aligners, such as exemplified in CPC A61C 9/00, 3/00, 19/04; A61B 1/04, 1/00, 1/32; G06K 9/62; and H04N 7/18.

### Description of the Prior Art

The conventional method of how to monitor aligner treatment in the orthodontist's office is simply to visually examine how well or closely the aligner fits with the patient's teeth. The position of the interior aligner surfaces relative to the tooth surfaces of various aligners in a series of aligners is observed by a trained orthodontist to assess progression with a series of aligners. Dental Monitoring SAS, Paris, France, has devised a holder for a smartphone that allows the patient to scan an image of their teeth and send to the practitioner's office for analysis by artificial intelligence to track progress with aligners.

What is needed is means and method whereby the patient may be able to make him or herself or assist the orthodontist in remotely making an assessment of fit of the aligners.

### BRIEF SUMMARY

The illustrated embodiments of the invention are directed to a method of monitoring the degree of fit of an aligner among a series of aligners defining a corresponding series of tooth positions comprising the following steps. Patient does not have to send images of his or her teeth to a practitioner, although that option is always available. Instead, the patient can self-assess visually the degree of fit and or use a chart as described below. The material disposed into the aligner will reflect more ultra violet light and appear more opaque where the aligner fit is the poorest, and reflect less ultra violet light and appear more translucent where the fit is better, and not be visible at all where the fit is best.

The method includes the steps of selecting an aligner in the series of aligners whose fit to a patient's teeth are to be tested to determine its fit with the selected aligner, disposing a nontoxic plastic material into the selected aligner, and setting the patient's teeth into the selected aligner containing the nontoxic plastic material. Next the patient's teeth and the selected aligner are illuminated with ultra violet light. The method also includes determining the amount of material disposed onto the interior aligner's surfaces by visual inspection by assessment of the material disposed therein, a good fit being indicated by a minimum of material extruded onto almost all of the interior aligner surfaces, and a poor fit being indicated by an excess of material extruded onto one or more locations of the aligner interior surfaces.

In the preferred embodiment the step of disposing the nontoxic plastic material into the aligner comprises disposing a nontoxic plastic material comprising an ultra violet reactive agent into the aligner, an intensity of light reflected by the nontoxic plastic material being proportional to the thickness of the material and the step of determining the amount of material disposed onto the interior aligner's surfaces by visual inspection by assessment of the material disposed therein comprising determining a good fit by a low degree of reflected ultra violet light from the disposed material and determining a poor fit by a high degree of reflected ultra violet light from the disposed material.

The step of determining a good fit by a low degree of reflected ultra violet light from the disposed material and determining a poor fit by a high degree of reflected ultra violet light from the disposed material comprises comparing an observed amount of reflected ultra violet light of the disposed material to a chart to determine when the reflected ultra violet light is a brightness indicative of either a good fit, a poor fit, or a corresponding brightness therebetween corresponding to at least one degree of fit therebetween.

The step of setting the patient's teeth into the selected aligner containing the nontoxic plastic material comprises improving the fit using cotton rolls or chewies.

The method further includes the steps of selecting a next aligner higher in the series of aligners whose fit to a patient's teeth are to be tested to determine whether it is appropriate to progress to use of the next aligner in the series, disposing a nontoxic plastic material into the selected next aligner, and setting the patient's teeth into the selected next aligner containing the nontoxic plastic material. Next the patient's teeth and the selected next aligner are illuminated with ultra violet light. The method also includes determining the amount of material disposed onto the interior next aligner's surfaces by visual inspection by assessment of the material disposed therein, a good fit being indicated by a minimum of material extruded onto almost all of the interior aligner surfaces, and a poor fit being indicated by an excess of material extruded onto one or more locations of the next aligner interior surfaces.

The method further includes the step of comparing an assessment of fit between the selected aligner and selected next aligner to determine which is a better fit with the corresponding selected aligner and selected next aligner to determine appropriateness of progressing higher in the series of aligners.

The method further includes the step of making an impression, a photograph or image of the lack of fit between the teeth and the selected aligner and the step of determining the amount of material disposed onto the interior aligner's surfaces by visual inspection or assessing a photograph or image of the filled aligner by assessment of the material disposed therein, includes assessing the photograph, image or three dimensional shape of the impression. Taking a photo or image of the material residing in the gaps caused by the poor fit increases the ability to see these areas, measures the degree of poor fitting, and aids the observer or Al in documenting the lack of fit and degree of lack of fit.

The scope of the invention also extends to a composition of matter for monitoring the degree of fit of an aligner among a series of aligners defining a corresponding series of tooth positions comprising a nontoxic plastic material for disposition into a selected aligner which is pressure moldable at room temperature to the patient's teeth into the selected aligner and which is removable from the selected aligner from the patient's teeth without substantial adherence to the teeth, the nontoxic plastic material being translucent and comprising an ultra violet reactive agent so that the amount of material disposed onto the interior aligner's surfaces when illuminated by an ultra violet light indicates by visual inspection of the material disposed therein of the degree of fit of the aligner to the tooth positions, a good fit being indicated by a minimum of material extruded onto almost all of the interior aligner surfaces and by a low degree of reflected ultra violet light from the disposed material, and a poor fit being indicated by an excess of material extruded onto one or more locations of the aligner interior surfaces and a high degree of reflected ultra violet light from the disposed material.

In one embodiment the nontoxic plastic material comprises a food stuff with a pudding consistency.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a depiction of an aligner set on the lower teeth, which shows virtually no color indicated by the lack of shading in the diagram in any gaps between the aligner and teeth and hence is indicative of an excellent fit to the aligner.

FIG. 2 is a depiction of an aligner set on the upper teeth, which shows only a small amount of color indicated by shading in gaps between the aligner and teeth, which is indicative of a good fit to the aligner.

FIG. 3 is a depiction of an aligner set on the upper teeth, which shows an appreciable amount of color indicated by shading in gaps between the aligner and teeth, which is indicative of a poor fit to the aligner.

FIG. 4 is a depiction of an aligner set on the upper teeth with the last aligner employed in a series for comparison with the fit shown by the next aligner up in the series.

FIG. 5 is a schematic diagram where an impression of the quality of the fit between teeth of a patient and an aligner is made by using the aligner as mold or tray for the impression made between the aligner and teeth.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

A series of aligners are prepared with a corresponding series or progression of tooth positions intended to be orthodontically created by the aligner series. What is disclosed below is a method to monitor in an orthodontist's office or for patient self-monitoring of the aligner fit, and whether if it is appropriate to move to the next aligner in a series.

A nontoxic liquid or viscous material (e.g. a food product that has a color, a colored liquid or a pudding consistency) is poured or injected into a tooth aligner. In one embodiment, the nontoxic liquid or viscous material comprises an ultra violet (UV) reactive material such as but not limited to petroleum jelly, quinine, vitamin B12, extracted chlorophyll, or other organic or chemical compounds now known or later devised which glow or reflect visible light when illuminated by ultralight waves. It should be expressly noted that the nontoxic liquid or viscous material comprising a UV reactive agent is meant to be illustrative purposes only and that other materials which are reactive to other wavelengths of light, including for example infrared waves, x-rays, or radio waves may also be used without departing from the original spirit and scope of the invention.

After the aligner comprising the nontoxic liquid or viscous material is inserted into the mouth and fitted to the teeth, a blacklight or other UV wave emitting device currently known in the art is passed over the aligner. The emitted UV waves interact with the UV reactive agent contained within the nontoxic liquid or viscous material to visibly show the areas where the teeth are “seating” well into the aligner as well as the areas where it is not “seating” or tracking well. The quality of the fit is indicated by the amount of material present between the teeth and the aligner interior surfaces, which is indicated by the visible intensity or degree of reflected light from the material between the teeth and the aligner. Specifically, with a good fit between the teeth and the aligner interior surfaces being determined by a low degree of reflected ultra violet light from the disposed material while a poor fit is determined by a high degree of reflected ultra violet light from the disposed material.

With regard to what defines a “low degree” or “high degree” of reflected ultra violet light, in one embodiment the user will know or understand what is considered to be a low degree or high degree of reflected ultra violet light based on repeated use and experience with observing multiple patient's and the fit of their respective aligners. In a more preferred embodiment however, the user will match an observed amount of ultra violet reflected light to a similar amount or degree of reflected ultra violet light displayed on a chart or card which comprises multiple different samples of reflected ultra violet light wherein each sample is keyed or corresponds to a predetermined threshold degree of brightness or intensity. By comparing the observed degree of reflected ultra violet light with the closest matching sample of reflected ultra violet light, the user can then determine if the observed degree of reflected ultra violet light is considered “low” or “high” and thus if a good or poor fit is present.

In a related embodiment, the nontoxic liquid or viscous material further comprises a food product that has a color or a colored liquid in addition to the UV reactive agent which is poured or injected into a tooth aligner. When the aligner is inserted into the mouth and fitted to the teeth, it visibly shows areas where the teeth are “seating” well into the aligner and areas where it is not “seating” or tracking well. The quality of the fit is indicated by the amount of material present between the teeth and the aligner interior surfaces, which is indicated by the visible intensity, degree, or amount of color of the material between the teeth and the aligner. Specifically, when the material is poured or injected into the aligner, it comprises a first shade which represents an average or starting amount of color. When a good fit between the teeth and the aligner interior surfaces has been determined, it is indicated by a low amount or a lighter color or shade relative to the first shade of the disposed material while a poor fit is determined by a high amount or darker color or shade relative to the first shade of the disposed material.

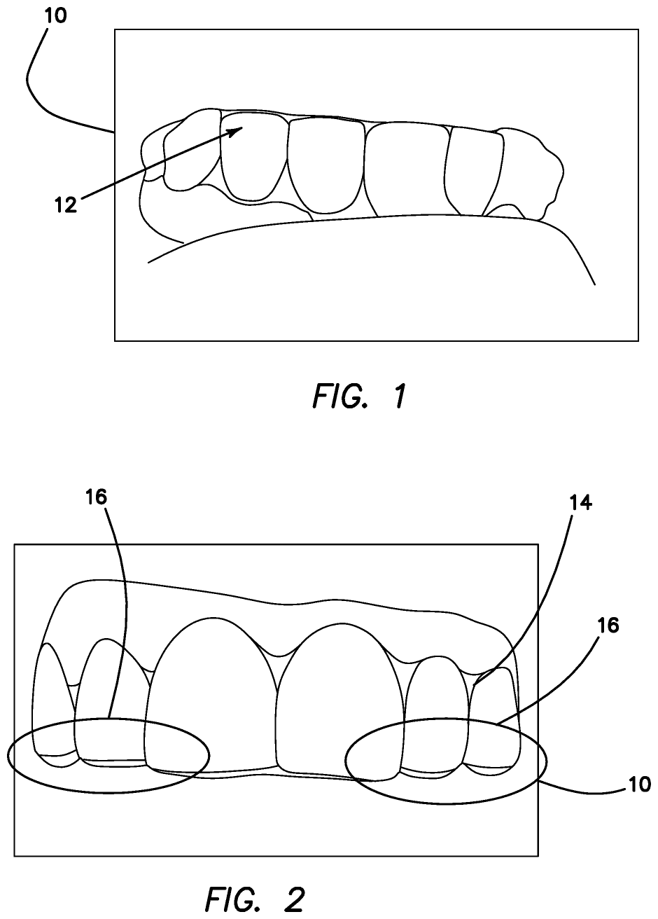

As shown in FIG. 1 an aligner 10 set on the lower teeth 12, which shows virtually no reflected visible light and/or color in any gaps between the aligner 10 and teeth 12 and hence is indicative of an excellent fit to the aligner.

As shown in FIG. 2 only some reflected visible light and/or color representing a small amount of material is extruded between the tooth surfaces of teeth 14 and the aligner 10 in areas 16, which indicates a good fit and the appropriateness of moving up in the aligner series to the next defined tooth positions. Biting down on cotton rolls or “chewies” to apply a distributed force in areas 16 may be used to attempt to adjust or improve the fit of aligner 10 to teeth 14.

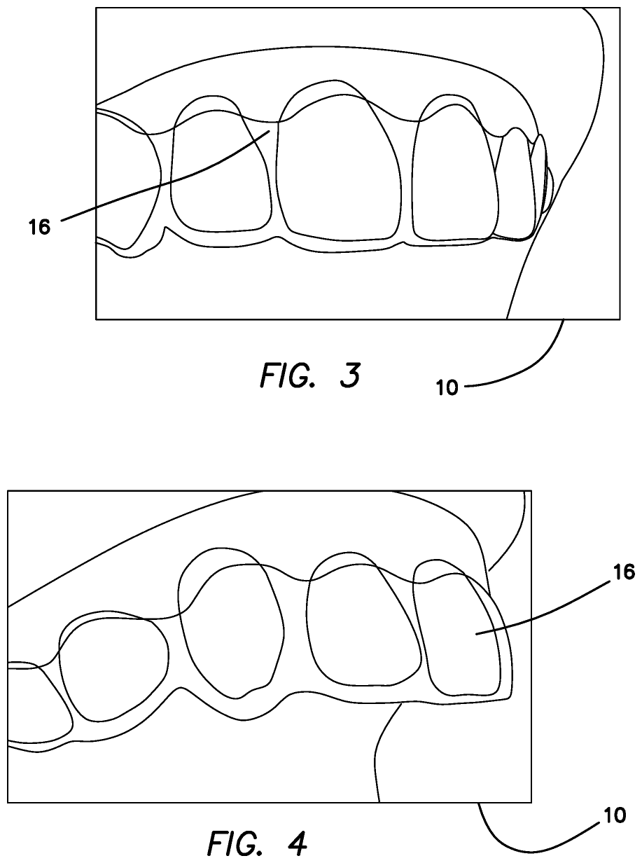

As shown in FIG. 3 more reflected visible light and/or a darker color representing a larger amount of material is allowed or extruded between the surfaces of teeth 14 and the surfaces of aligner 10, thus indicating a poor fit and the inappropriateness of moving up in the aligner series to the next defined tooth positions. Again, the use of cotton rolls or chewies to readjust the fit of aligner 10 to teeth 14 is then made. If there is no improvement of fit, then the patient may be urged to report the same to his or her orthodontist's office for consultation and assistance.

The depiction of FIG. 3 may, for example, be a step wherein the patient has moved up the series of aligners to test if the next aligner 10 in the series presents a better fit. Thus, in FIG. 4 the patient has inserted the last aligner 10 in the series to determine if a better fit is achieved than seen with the next aligner 10 in the series as shown in FIG. 3. If a return to the last aligner 10 in the series after adjustment using cotton rolls or chewies as shown in FIG. 4 does not indicate a better fit than seen in the fit of the next aligner 10 in the series as shown in FIG. 3, then the patient is directed to his or her orthodontist's office for consultation and assistance.

While the dentist/orthodontist or their staff is trained and experienced in assessing the differences in the amount of color or intensity of reflected visible light and locations with respect to aligner fit, it is harder for a patient to assess aligner fit, and the patterns of reflected visible light are also difficult to pick it up in photos, even those taken with specialized self-monitoring imaging systems designed for this purpose, which are now being marketed for the orthodontic market. While at home or in the office, the material is placed in an aligner 10, or for example used with every 5th aligner, to see if there is more than a thin line of the material at the edges of the teeth 12, 14. If it is more than in seen in comparison to sample images which are provided to the patient, the patient does not move to the next aligner and devices, such as chewies or cotton rolls, are employed to help seat the aligners better.

The test can be used as often as the patient likes. Just prior to moving up in the series to the next aligner, it is best to determine if they should change to the next aligner or extend the wearing of the present aligner, perhaps using devices, such as chewies or cotton rolls, to help the aligner seat better. Every 5th aligner may be too long of an interval. Most aligners are changed weekly, although most direct-to-consumer or in-house made aligners are worn for two weeks, more if just worn in the evening.

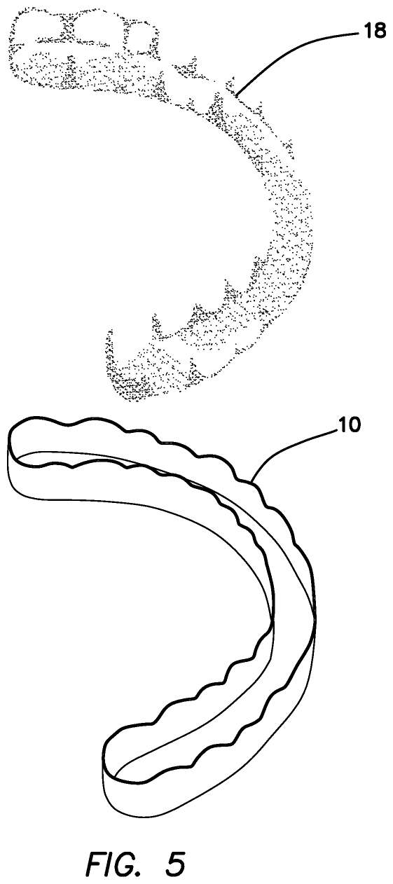

As diagrammatically shown in FIG. 5 the nontoxic material could also be similar to that used for making dental impressions. The patient seats the aligner 10 on the teeth, takes a “selfie” of their teeth, and checks the fit. The impression 18 of the degree of fit can then just be pulled out of the tray or aligner 10 as a three dimensional impression 18 of the degree of misalignment or lack of fit, since it has no adhesive properties. Some material may get stuck between spaces in the teeth, this would have to be removed by the patient or staff if in the office with a brush or pick. The patient, if self-monitoring may take a picture of the impression 18 showing the degree and locations of misfit with aligner 10 after it is removed to send to the treating practitioner to assess how well the aligner is fitting, assuming that a good intact impression 18 is formed and does not get stuck to the teeth.

The patient may also evaluate the fit with comparison to a light intensity, brightness, or luminescence chart (not shown). The chart could be used at, for example, the edge of the front teeth 12, 14. If the material is “thick” or “bright”, indicating a poor fit, the material would be brighter as defined by the chart, as compared to where the material is “thinned out” or “darker” where the tray or aligner is fitting well, where the material would be darker, more transparent or translucent as defined by the chart. The patient is then able to rate the fit themselves more precisely based on assessments interpreted with use of the chart. The chart could include information keyed to specified intensities, such as “wear current aligner for another week and retest”, or “use chewies (or something you bite on) every 4 hours to seat aligner better, retest in X number of days.”

Similarly, the patient may also evaluate the fit with comparison to a color chart (not shown). The chart could be used at, for example, the edge of the front teeth 12, 14. If the material is “thick”, indicating a poor fit, the color would be darker as defined by the color chart, as compared to where the material is “thinned out” where the tray or aligner is fitting well, where the material's color would be lighter, more transparent or translucent as defined by the color chart. The patient is then able to rate the fit themselves more precisely based on assessments interpreted with use of the color chart. The color chart could include information keyed to specified color intensities, such as “wear current aligner for another week and retest”, or “use chewies (or something you bite on) every 4 hours to seat aligner better, retest in X number of days.”

The patient, if self-monitoring, could also take a picture of the aligner in the mouth or, after they removed the aligner, send the photo to the treating doctor. Alternatively, an app or attachment for a smartphone would emit UV waves onto the aligner directly, and/or assess the image over teledentistry apps, FaceTime, Duo, and the like.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. A method of monitoring the degree of fit of an aligner among a series of aligners defining a corresponding series of tooth positions comprising:
selecting an aligner in the series of aligners whose fit to a patient's teeth are to be tested to determine its fit with the selected aligner;
disposing a nontoxic plastic material into the selected aligner;
setting the patient's teeth into the selected aligner containing the nontoxic plastic material;
illuminating the patient's teeth and the selected aligner with ultra violet light; and
determining the amount of material disposed onto the interior aligner's surfaces by visual inspection by assessment of the material disposed therein, a good fit being indicated by a minimum of material extruded onto almost all of the interior aligner surfaces, and a poor fit being indicated by an excess of material extruded onto one or more locations of the aligner interior surfaces.

2. The method of claim 1 where disposing the nontoxic plastic material into the aligner comprises disposing a nontoxic plastic material comprising an ultra violet reactive agent into the aligner, an intensity of light reflected by the nontoxic plastic material being proportional to the thickness of the material, and
where determining the amount of material disposed onto the interior aligner's surfaces by visual inspection by assessment of the material disposed therein comprises determining a good fit by a low degree of reflected ultra violet light from the disposed material and determining a poor fit by a high degree of reflected ultra violet light from the disposed material.

3. The method of claim 2 where determining a good fit by a low degree of reflected ultra violet light from the disposed material and determining a poor fit by a high degree of reflected ultra violet light from the disposed material comprises comparing an observed amount of reflected ultra violet light of the disposed material to a chart to determine when the reflected ultra violet light is a brightness indicative of either a good fit, a poor fit, or a corresponding brightness therebetween corresponding to at least one degree of fit therebetween.

4. The method of claim 3 where comparing the observed amount of reflected ultra violet light of the disposed material to the chart comprises making a visual comparison between the brightness of the disposed material and a printed brightness sample, or scanning the disposed material to create a scanned image and assessing the brightness of the scanned image using an in situ or remote computer.

5. The method of claim 1 where disposing the nontoxic plastic material into the aligner comprises disposing a colored nontoxic plastic material comprising a first shade into the aligner; and
where determining the amount of material disposed onto the interior aligner's surfaces by visual inspection by assessment of the material disposed therein comprises determining a good fit by a lighter color relative to the first shade of the disposed material and determining a poor fit by a darker color relative to the first shade of the disposed material.

6. The method of claim 1 further comprising:
selecting a next aligner higher in the series of aligners whose fit to a patient's teeth are to be tested to determine whether it is appropriate to progress to use of the next aligner in the series;
disposing the nontoxic plastic material into the selected next aligner;
setting the patient's teeth into the selected next aligner containing the nontoxic plastic material;
illuminating the patient's teeth and the selected next aligner with ultra violet light; and
determining the amount of material disposed onto the interior next aligner's surfaces by visual inspection by assessment of the material disposed therein, a good fit being indicated by a minimum of material extruded onto almost all of the interior aligner surfaces, and a poor fit being indicated by an excess of material extruded onto one or more locations of the next aligner interior surfaces.

7. The method of claim 6 where disposing the nontoxic plastic material into the next aligner comprises disposing a nontoxic plastic material comprising a ultra violet reactive agent into the next aligner, an intensity of light reflected by the nontoxic plastic material being proportional to the thickness of the material, and
where determining the amount of material disposed onto the interior next aligner's surfaces by visual inspection by assessment of the material disposed therein comprises determining a good fit by a low degree of reflected ultra violet light from the disposed material and determining a poor fit by a high degree of reflected ultra violet light from the disposed material.

8. The method of claim 6 further comprising comparing an assessment of fit between the selected aligner and selected next aligner to determine which is a better fit with the corresponding selected aligner and selected next aligner to determine appropriateness of progressing higher in the series of aligners.

9. The method of claim 6 where disposing the nontoxic plastic material into the next aligner comprises disposing a colored nontoxic plastic material comprising a first shade into the aligner; and
where determining the amount of material disposed onto the interior next aligner's surfaces by visual inspection by assessment of the material disposed therein comprises determining a good fit by a lighter color relative to the first shade of the disposed material and determining a poor fit by a darker color relative to the first shade of the disposed material.

10. The method of claim 1 further comprising making an impression, photograph or image of the lack of fit between the teeth and the selected aligner, and
where determining the amount of material disposed onto the interior aligner's surfaces by visual inspection by assessment of the material disposed therein comprises assessing the photograph or image, or three dimensional shape of the impression.

11. A method of monitoring the degree of fit of an aligner among a series of aligners defining a corresponding series of tooth positions comprising:
selecting an aligner in the series of aligners whose fit to a patient's teeth are to be tested to determine its fit with the selected aligner;
disposing a colored nontoxic plastic material comprising an ultra violet reactive agent into the selected aligner, the colored nontoxic plastic material comprising a first shade;
setting the patient's teeth into the selected aligner containing the colored nontoxic plastic material;
illuminating the patient's teeth and the selected aligner with ultra violet light; and
determining the amount of material disposed onto the interior aligner's surfaces by visual inspection by assessment of the material disposed therein, a good fit being indicated by the disposed material comprising a lighter color relative to the first shade of the disposed material and by a low degree of reflected ultra violet light from the disposed material, and a poor fit being indicated by the disposed material comprising a darker color relative to the first shade of the disposed material and a high degree of reflected ultra violet light from the disposed material.

12. The method of claim 11 where setting the patient's teeth into the selected aligner containing the nontoxic plastic material comprises improving the fit using cotton rolls or chewies.

13. The method of claim 11 further comprising:
selecting a next aligner higher in the series of aligners whose fit to a patient's teeth are to be tested to determine whether it is appropriate to progress to use of the next aligner in the series;
disposing the colored nontoxic plastic material into the selected next aligner;
setting the patient's teeth into the selected next aligner containing the colored nontoxic plastic material;
illuminating the patient's teeth and the selected next aligner with ultra violet light; and
determining the amount of material disposed onto the interior next aligner's surfaces by visual inspection by assessment of the material disposed therein, a good fit being indicated by the disposed material comprises a lighter color relative to the first shade of the disposed material, and a poor fit being indicated by the disposed material comprises a darker color relative to the first shade of the disposed material.

14. The method of claim 13 where determining the amount of material disposed onto the interior next aligner's surfaces by visual inspection by assessment of the material disposed therein comprises determining a good fit by a low degree of reflected ultra violet light from the disposed material and determining a poor fit by a high degree of reflected ultra violet light from the disposed material.

15. The method of claim 13 further comprising comparing an assessment of fit between the selected aligner and selected next aligner to determine which is a better fit with the corresponding selected aligner and selected next aligner to determine appropriateness of progressing higher in the series of aligners.

16. The method of claim 15 where setting the patient's teeth into the selected aligner and selected next aligner containing the colored nontoxic plastic material comprises improving the fit using cotton rolls or chewies.

17. The method of claim 11 further comprising making an impression of the lack of fit between the teeth and the selected aligner and
where determining the amount of material disposed onto the interior aligner's surfaces by visual inspection by assessment of the material disposed therein, comprises assessing the three dimensional shape of the impression.

18. The method of claim 11 where determining a good fit by the disposed material comprising a lighter color relative to the first shade of the disposed material and a low degree of reflected ultra violet light from the disposed material and determining a poor fit by the disposed material comprising a darker color relative to the first shade of the disposed material and by a high degree of reflected ultra violet light from the disposed material comprises comparing an observed portion of the disposed material to a chart to determine when the observed portion of the disposed material is indicative of either a good fit, a poor fit, or a corresponding brightness therebetween corresponding to at least one degree of fit therebetween.

19. A composition of matter for monitoring the degree of fit of an aligner among a series of aligners defining a corresponding series of tooth positions comprising a nontoxic plastic material for disposition into a selected aligner which is pressure moldable at room temperature to the patient's teeth into the selected aligner and which is removable from the selected aligner from the patient's teeth without substantial adherence to the teeth, the nontoxic plastic material being translucent and comprising an ultra violet reactive agent so that the amount of material disposed onto the interior aligner's surfaces when illuminated by an ultra violet light indicates by visual inspection of the material disposed therein of the degree of fit of the aligner to the tooth positions, a good fit being indicated by a minimum of material extruded onto almost all of the interior aligner surfaces and by a low degree of reflected ultra violet light from the disposed material, and a poor fit being indicated by an excess of material extruded onto one or more locations of the aligner interior surfaces and a high degree of reflected ultra violet light from the disposed material.

20. The composition of matter of claim 19 where the nontoxic plastic material comprises a food material with a pudding consistency.
